(19) United States
(12) Patent Application Publication
(10) Pub. No.: US 2017/0298739 A1
(43) Pub. Date: Oct. 19, 2017

(54) Bolt On Seal Ring

(71) Applicant: Siemens Energy, Inc., Orlando, FL (US)

(72) Inventors: Chirag B. Patel, Charlotte, NC (US); Michael Skarbowski, Charlotte, NC (US); Kevin M. Light, Maitland, FL (US); William J. Curtin, Fort Mill, SC (US)

(21) Appl. No.: 15/130,042

(22) Filed: Apr. 15, 2016

(51) Int. Cl. F01D 5/08; F01D 11/00

(52) U.S. Cl. CPC F01D 5/085; F01D 11/00; F05D 2220/32; F05D 2260/20; F05D 2260/14

(57) ABSTRACT

A device to route cooling air to a turbine blade is provided. The device includes a seal ring having an L-shaped cross section configured to abut a turbine disc. The seal ring includes a radial portion extending radially with respect to a rotor and an axial portion extending axially with respect to the rotor. The seal ring also includes a plurality of radial cooling holes disposed within the radial portion of the seal ring and arranged circumferentially around the seal ring. The plurality of cooling holes route cooling air from a device configured to impart tangential momentum to the cooling air to a turbine blade in order to cool the turbine blade. A system and a method to improve a flow of rotor cooling air to a turbine blade are also provided.

### BACKGROUND

### 1. Field

The present application relates to gas turbines, and more particularly to a device to route cooling air to a turbine blade. A system to improve a flow of rotor cooling air and a method to improve a flow of rotor cooling air to a turbine blade are also provided.

### 2. Description of the Related Art

During operation of the gas turbine, turbine blades are exposed to extremely high temperatures. Various methods are employed for their cooling, including routing rotor cooling air to the turbine blades. Traditionally, an air separator is used to separate the air into two paths, one leading into the row one turbine disc, also referred to as the turbine disc one, for cooling of the row one blade platform and the other path leading to the rotor for cooling of the rotor discs and turbine blades. After the air separator routes the air to the rotor, the air is then brought up to the rotational speed of the rotor. This process incurs undesirable aerodynamic losses as the work of the rotor associated with bringing the air up to rotational speed is high. A pre-swirler device may be used to impart tangential momentum in order to get the rotor cooling air up to the rotational speed of the rotor quicker than the process used with the air separator. Using the pre-swirler device to swirl the incoming rotor cooling air reduces losses and improves the overall efficiency of the gas turbine which leads to the improved cooling ability of the rotor cooling air to cool the turbine blades.

### SUMMARY

Briefly described, aspects of the present disclosure relate to a device to route cooling air to the turbine blade.

A first aspect of provides a device to route cooling air to a turbine blade. The device includes a seal ring having an L-shaped cross section configured to abut a turbine disc. The seal ring comprises a radial portion extending radially with respect to a rotor and an axial portion extending axially with respect to the rotor. The seal ring also comprises a plurality of radial cooling holes disposed within the radial portion of the seal ring and arranged circumferentially around the seal ring. The plurality of cooling holes route cooling air from a device configured to impart tangential momentum to the cooling air to a turbine blade in order to cool the turbine blade.

A second aspect provides a system to improve a flow of rotor cooling air to a turbine blade. The system includes a swirler device configured to swirl a rotor cooling air with a rotation of the gas turbine. The system also includes a turbine disc and an L-shaped seal ring abutting the turbine disc and configured to route the rotor cooling air through a plurality of radial cooling holes within the seal ring from the swirler device to a turbine blade in order to cool the turbine blade.

A third aspect of provides a method to improve a flow or rotor cooling air to a turbine blade. The method includes swirling rotor cooling air such that the cooling air is rotating at the speed of the rotor and routing the swirled cooling air to a turbine blade through a radial hole in an L-shaped ring for cooling.

### BRIEF DESCRIPTION OF THE DRAWINGS

FIG. 1 illustrates a longitudinal cross section of the mid-section of a gas turbine,

FIG. 2 illustrates a longitudinal cross section of a seal ring,

FIG. 3 illustrates a partial perspective version of the seal ring, and

FIG. 4 illustrates a cross section of the seal ring.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

The pre-swirler device, as described above, would physically replace the air separator in existing gas turbines. In order to integrate the pre-swirler into existing gas turbines, an additional device may be needed to replace the functionality of the air separator; that is to separate the cooling air into the two paths, one path into the row one turbine blade platform and the other path to the turbine rotor discs and turbine blades. Additionally, the additional device may be needed to provide a sealing function for the pre-swirler housing. The additional device and its functionality separating the cooling air into two paths may also be incorporated into the design of a new engine.

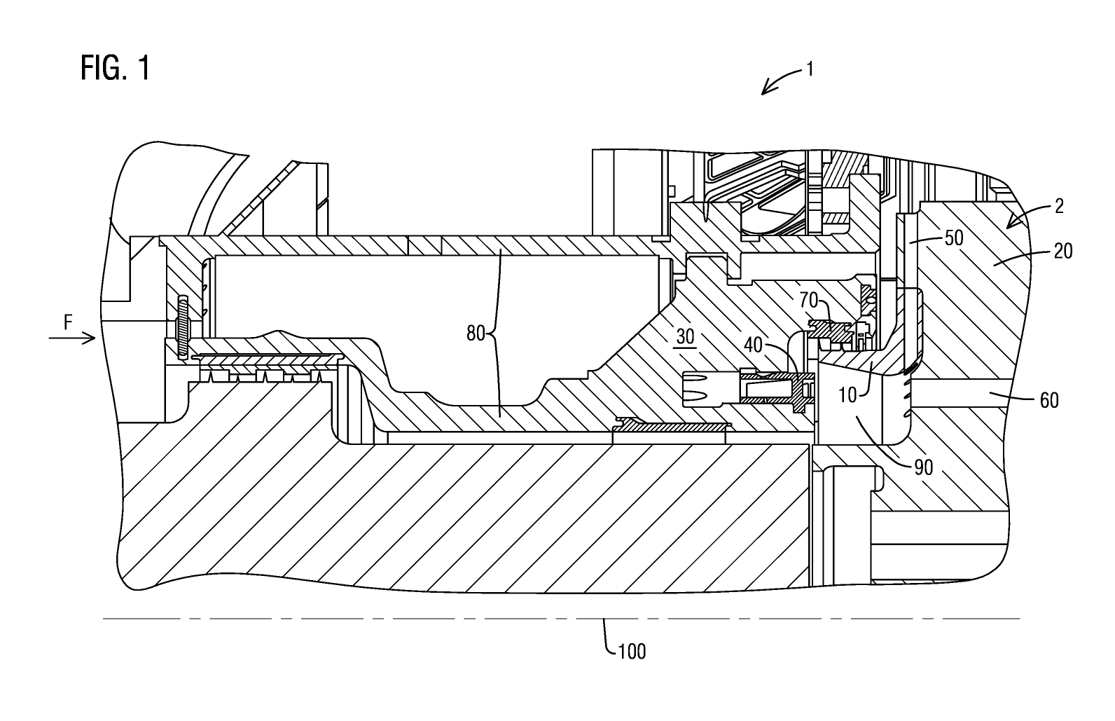

FIG. 1 illustrates a longitudinal cross section of a mid-section 1 of a gas turbine including a pre-swirler device 30. Additionally, FIG. 1 shows a partial longitudinal view of the gas turbine's turbine section 2 including the turbine one disc 20 and a proposed seal ring device 10. The pre-swirler device 30 includes a pre-swirler inner and outer housing, 80 and a pre-swirler nozzle 40. The pre-swirler device 30 is a stationary, non-rotating device, whereas the turbine one disc 20 and the proposed seal ring device 10 rotate with respect to a rotor centreline 100. The pre-swirler nozzle 40 imparts a tangential momentum to the rotor cooling air F which enters the pre-swirler device 30 from the rotor air cooling system of the gas turbine. The pre-swirler nozzle 40 may also be used to point the rotor cooling air F in a desired direction. After exiting the pre-swirler nozzle 40, the rotor cooling air F enters a cavity 90 disposed between the pre-swirler device 30 and the turbine disc one 20. At least one seal 70 may be used for sealing the pre-swirler inner housing 80 against the seal ring device 10 in order to minimize the loss of rotor cooling air when routing it toward the turbine blades.

The seal ring device 10 is disposed between the pre-swirler device 30 and the turbine disc one 20 and above the cavity 90 into which the swirled rotor cooling air F enters at the speed of the rotor after being expelled by the pre-swirler nozzle 40. The turbine one disc 20 includes multiple radial cooling passages, of which one is illustrated in the Figures, 50 through which a portion of the rotor cooling air flows radially to the turbine blade for its cooling. Additionally, an axial cooling passage 60 exists in the turbine disc one 20 for a further portion of the rotor cooling air F to flow in order to cool the further stages of turbine discs and turbine blades.

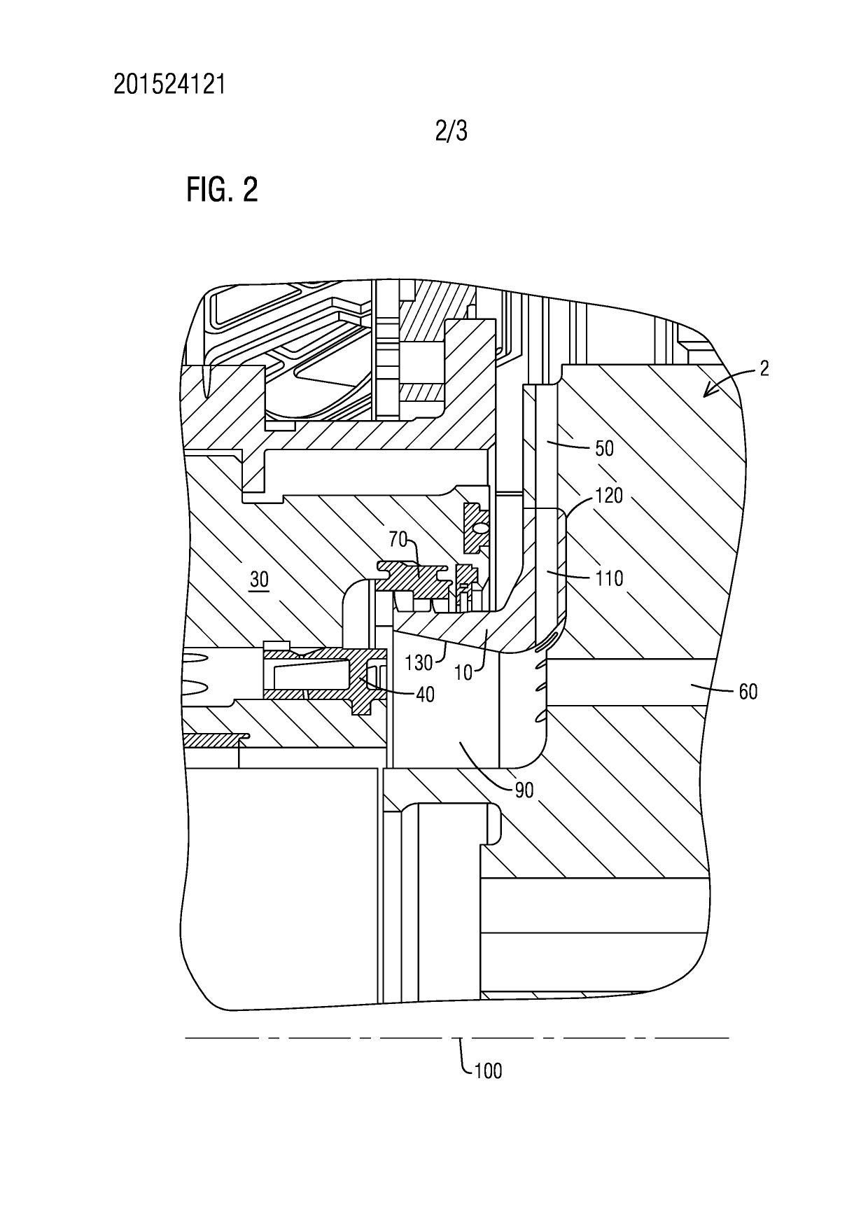

FIG. 2 illustrates a longitudinal cross section of the seal ring device 10. The seal ring 10 includes an L-shaped cross section as seen in the FIG. 2. The seal ring 10 thus comprises a radial portion 120 extending radially with respect to a rotor centreline 100 and an axial portion 130 extending axially with respect to a rotor centreline 100. The seal ring 10 may include a plurality of radial cooling holes 110 disposed within the radial portion 120 of the seal ring 10. The plurality of radial cooling holes 110 may be arranged circumferentially around the seal ring 10. Each of the plurality of radial cooling holes 110 route cooling air from the pre-swirler device 30 to a turbine blade.

A contour of the radially interior surface of the seal ring 10 may be optimized using computational fluid dynamics such that the pressure loss of the rotor cooling air is reduced and the performance of the rotor cooling air to cool the turbine blades is improved. In the embodiment shown in FIG. 2, the contour of the radially interior surface includes a radially downward inclination. In this embodiment, the contour acts as a nozzle or funnel to collect the air and efficiently point and direct the air to the radial cooling air holes 110 in the seal ring 10 and the axial cooling holes 60 in the turbine disc one 20.

A radially exterior surface of the axial portion 130 may be adapted to accommodate the pre-swirler sealing 70. The pre-swirler sealing 70 may be designed to minimize the leakage of cooling air through the seal 70. Additionally, the pre-swirler sealing 70 keeps the cool air at a higher pressure within the cavity 90 in order to force the cool air into the turbine blades. In the embodiment shown in FIG. 2, the pre-swirler sealing 70 includes a plurality of labyrinth seals as well as a brush seal, and a honeycomb seal.

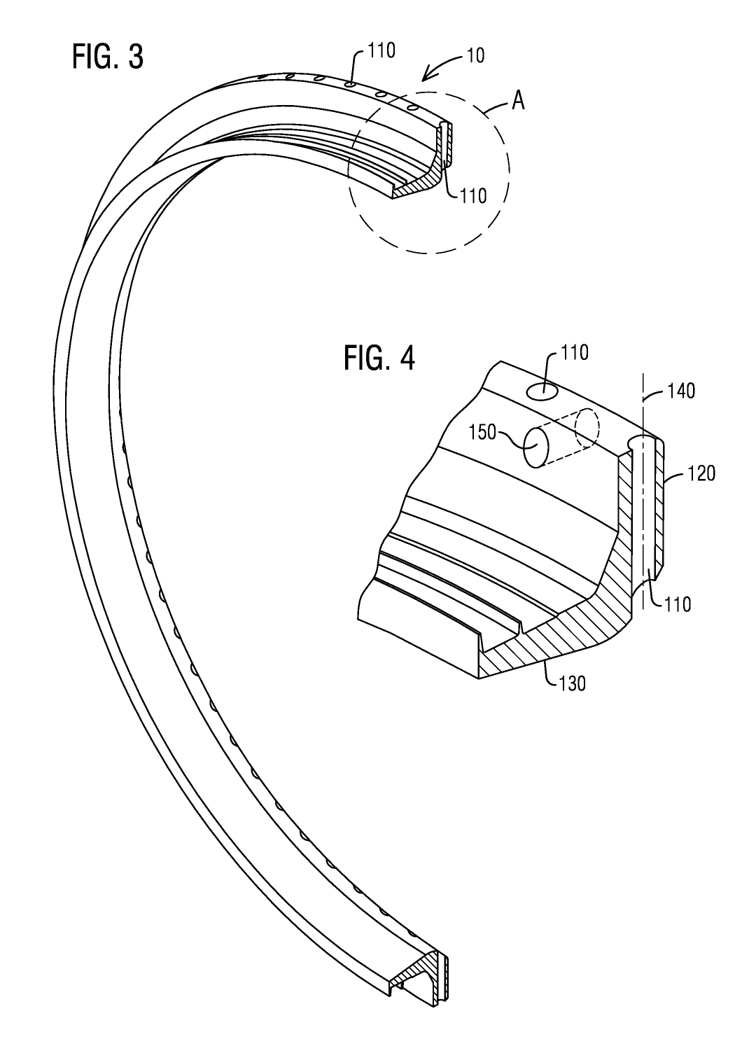

In the embodiment shown in FIG. 3, a partial perspective view of the seal ring 10 is shown. In this view, only 180 degrees of the seal ring 10 is shown such that the L-shaped cross section may also be viewed. However, in an embodiment the seal ring 10 would be constructed as a full 360 degree ring. The advantage of making the seal ring 10, 360 degrees would be so that the seal ring 10 may support itself in the hoop stress direction and therefore have a minimal stress impact on the turbine disc one 20. In another embodiment, the seal ring 70 may be segmented such that ring segments fit together to form a complete 360 degree seal ring 70. From FIG. 3, the circumferential arrangement of the cooling holes 110 may be seen.

FIG. 4 illustrates a close up perspective view of the L-shaped cross section shown in detail A of FIG. 3. A cross section of a cylindrically-shaped cooling hole 110 may be seen in the embodiment of FIG. 4. However, one skilled in the art would understand that cooling holes with different shaped cross sections are also possible. Additionally, in the shown embodiment the axis 140 of the cooling hole lies perpendicular to the centreline of the rotor 100. However, each of the plurality of cooling holes 110 may be inclined relative to a radial length of the radial portion 120 of the seal ring 10 in order to promote a more efficient delivery of rotor cooling air to the turbine blade. As such, the axis 140 of the cooling hole would be inclined relative to the centreline of the rotor 100. FIG. 4 also shows an embodiment of the contour of a radially exterior surface of the axial portion 130 of the seal ring 10. The contour may be adapted to accommodate the sealing of the pre-swirler device 30.

The seal ring 10 may comprise the same or similar material as the turbine one disc 20. Using the same or similar material for the seal ring 10 as that of the turbine one disc 20 would prevent significant differences in the rate of thermal expansion between the two components during operation of the gas turbine. A significant difference in the rate of thermal expansion may cause the misalignment of the radial cooling hole 11 and the radial cooling hole 50 of the turbine disc one 20 such that the amount of the cooling air reaching the turbine 1 blade would decrease, for example. The seal ring 10 may thus comprise a low alloy steel which is traditionally used for the turbine disc material.

The seal ring 10 is configured to abut the turbine disc 20 such that the cooling passage 50 of the turbine one disc is aligned with the radial cooling hole 110 of the seal ring 10. The seal ring 10 may also comprise attachment means to attach the seal ring 10 to the turbine one disc 20. As illustrated in FIG. 4, a hole 150 may be positioned in the radial portion 120 of the seal ring 10 to accommodate a bolt or a sheer pin, for example. The hole 150 would be positioned such that it would not interfere with any of the plurality of radial cooling holes 110. For example, the hole 150 may be positioned between adjacent radial cooling holes 110 in the circumferential direction. The attachment means may also include interference fit (shrink fits) or welding the seal ring 10 to the turbine one disc 20. A weld preparation area may include a radially exterior surface of the seal ring 10 surrounding, but not including, each radial cooling hole 110.

Referring to FIGS. 1 and 2, a system to improve a flow of rotor cooling air to a turbine blade is also provided. The system includes a device configured to swirl a rotor cooling air with a rotation of the gas turbine. In an embodiment as shown in FIGS. 1-2, the device is a pre-swirler device 30 as described above. In a mid-section of a gas turbine 1, the pre-swirler device 30 may physically replace an air separator when retrofitting a gas turbine with the pre-swirler device 30. The pre-swirler nozzle 40 imparts a tangential momentum to the rotor cooling air and expels this swirled cooling air into a cavity 90. In an embodiment, the pre-swirler nozzle 40 may direct the cooling air in a direction of a radial cooling hole 110. The pre-swirler nozzle 40 may direct the cooling air in a direction of an axial cooling hole 60. An axial portion 130 of an L-shaped seal ring device 10 creates a seal with the pre-swirler device 30. A radial portion 120 of the seal ring device 10 may abut a turbine disc 20. When retrofitting an existing gas turbine with the seal ring 10, the turbine disc one 20 may need a modification in order to accommodate the geometry of the seal ring 10. The modification may include machining the turbine disc one 20 to accommodate the geometry of the seal ring 10. The seal ring 10 may be attached as described above to the turbine disc 20.

The seal ring 10 includes a plurality of radial cooling holes 110 extending radially through the radial portion 120 of the seal ring 10. These radial cooling holes 110 may be aligned with radial cooling passages 50 within the turbine disc one 20 such that the cooling air F is efficiently routed from the pre-swirler device 30 to the turbine blade. The turbine disc 20 may also include an axial cooling passage 60 which routes cooling air to turbine blades in a flow direction downstream from the turbine disc one 20. An example of a cooling air split between the radial cooling passage 50 and the axial cooling passage 60 may be 50% through the radial cooling passage 50 and 48% through the axial cooling passage 60 with approximately 2% lost through leakage. The turbine blades themselves control the amount of cooling air flow they consume. The more cooling holes 110 each turbine blade includes, the higher amount of cooling air flow the turbine blade takes in.

Referring to FIGS. 1-4, a method to improve a flow of rotor cooling air F to a turbine blade is also provided. As described above, the pre-swirler device 40 is described above to swirl the rotor cooling air F to the speed of the rotor and expel this air through a pre-swirler nozzle 40 into a cavity 90. The swirled cooling air is then routed through a seal ring 10 to the first row turbine blade for its cooling.

In an embodiment, the method includes attaching the seal ring 10 to a turbine disc one 20. The seal ring 10 may be attached to the turbine disc one 20 using through bolts, sheer pins, interference fits, or by welding as described above. In an embodiment, a plurality of through holes 150 may be positioned in a radial portion 120 of seal ring 10 through which a bolt or sheer pin may be inserted, for example, and fastened in order to securely attach the seal ring 10 to the turbine disc one 20. In another embodiment, the seal ring 10 is welded to the turbine disc one 20.

The attaching of the seal ring 10 may include aligning a plurality of radial cooling holes 110 in the seal ring 10 with a corresponding cooling passage 50 in the turbine one disc 20 such that the flow of cooling air cools the row one turbine blade. An interference fit may be provided between the seal ring 10 and the turbine disc 20 by heating up the turbine disc 20 to center its cooling passage 60 with the radial cooling hole 110 of the seal ring 10.

In an embodiment, especially when retrofitting an existing gas turbine with a seal ring 10, the turbine disc 20 may need to be machined in order to accommodate the geometry of the seal ring 10 such that the seal ring 10 abuts the turbine disc 20. The machining would precede the attaching of the seal ring 10.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A device to route cooling air to a turbine blade, comprising:
a seal ring having an L-shaped cross section configured to abut a turbine disc wherein the seal ring comprises a radial portion extending radially with respect to a rotor and an axial portion extending axially with respect to the rotor;
a plurality of radial cooling holes disposed within the radial portion of the seal ring and arranged circumferentially around the seal ring;
wherein the plurality of cooling holes route cooling air from a device configured to impart tangential momentum to the cooling air to a turbine blade in order to cool the turbine blade.

2. The device as claimed in claim 1, wherein a material of the L-shaped ring is a low alloy steel.

3. The device as claimed in claim 1, wherein a material of the seal ring is the same as a material of the turbine disc.

4. The device as claimed in claim 1, further comprising attachment means for attaching the device to the turbine disc.

5. The device as claimed in claim 4, wherein the attachment means are selected from the group consisting of bolts, a welded joint, and a sheer pin.

6. The device as claimed in claim 1, wherein a contour of the radially interior surface of the axial portion is optimized using computational fluid dynamics in order to reduce the pressure loss of the cooling air.

7. The device as claimed in claim 1, wherein a radially exterior surface of the axial portion is adapted to accommodate a seal such that leakage of cooling air through the seal is minimized.

8. The device as claimed in claim 1, wherein each of the plurality of radial cooling holes are inclined relative to a radial length of the radial portion to promote a more efficient delivery of cooling air to the turbine blade.

9. A system to improve a flow of rotor cooling air to a turbine blade, comprising:
a swirler device configured to swirl a rotor cooling air with a rotation of the gas turbine;
a turbine disc;
an L-shaped seal ring abutting the turbine disc and configured to route the rotor cooling air through a plurality of radial cooling holes within the seal ring from the swirler device to a turbine blade in order to cool the turbine blade.

10. The system as claimed in claim 9, wherein the pre-swirler nozzle directs the cooling air into a cavity and towards a turbine disc.

11. The system as claimed in claim 9, wherein the plurality of radial cooling holes in the seal ring align with a plurality of radial cooling passages in the turbine disc.

12. The system as claimed in claim 10, wherein the pre-swirler nozzle directs the rotor cooling air such that approximately 50% of the rotor cooling air is routed through the plurality of radial cooling holes,
wherein approximately 48% of the cooling air is routed through the axial cooling passages to further turbine blades downstream from the turbine disc, and
wherein approximately 2% of the cooling air is lost through leakage.

13. The system as claimed in claim 10, wherein an inclination of the radial cooling holes relative to a radial length of the radial portion promotes a more efficient delivery of cooling air to the turbine blade.

14. A method to improve a flow of rotor cooling air to a turbine blade, comprising:
swirling rotor cooling air such that the cooling air is rotating at the speed of the rotor; and
routing the swirled cooling air to a turbine blade through a radial hole in an L-shaped seal ring for cooling.

15. The method as claimed in claim 10, further comprising attaching the seal ring to a turbine disc.

16. The method as claimed in claim 14, wherein the attaching includes positioning a plurality of through holes in a radial portion of seal ring, and
wherein a bolt or sheer pin is inserted into each through hole and fastened in order to securely attach the seal ring to the turbine disc.

17. The method as claimed in claim 14, wherein the attaching includes welding the seal ring to the turbine disc.

18. The method as claimed in claim 14, further comprising machining the turbine disc in order to accommodate the geometry of seal ring such that the seal ring abuts the turbine disc,
wherein the machining precedes the attaching of the seal ring.

19. The method as claimed in claim 15,
wherein the seal ring includes a plurality of radial holes arranged circumferentially around the seal ring, and
wherein the attaching includes aligning each radial cooling hole with a corresponding cooling hole in the turbine disc.

20. The method as claimed in claim 10, wherein the attaching includes heating up the turbine disc in order to center a cooling hole in the turbine disc with the radial cooling hole and to provide an interference fit with the seal ring.
